(19) United States
(12) Patent Application Publication
(10) Pub. No.: US 2024/0122401 A1
(43) Pub. Date: Apr. 18, 2024

(54) FEEDING DEVICE FOR COOKING MACHINE

(71) Applicant: Shanghai Aican Robot (Group) Co., Ltd., Shanghai (CN)

(72) Inventors: Qing HE, Shanghai (CN); Guang HE, Shanghai (CN)

(21) Appl. No.: 18/389,684

(22) Filed: Dec. 19, 2023

Related U.S. Application Data
(63) Continuation-in-part of application No. PCT/CN2022/095988, filed on May 30, 2022.

(30) Foreign Application Priority Data
Jul. 30, 2021 (CN) 202110868644.2

(51) Int. Cl. A47J 36/00

(52) U.S. Cl. CPC A47J 36/00

(57) ABSTRACT

A feeding device for cooking machine, includes: a box supporting assembly, a food material box, a movable baffle, and support assemblies. The box supporting assembly includes a base frame and a box frame. The box frame is disposed on one side of the base frame to support the food material box. The movable baffle is disposed on the base frame. The food material box includes a discharging end attached to a lower surface of the movable baffle. The support assemblies are respectively disposed on two opposite sides of the base frame, and operate to hang the box supporting assembly modularly over a body frame of a cooking machine or detach the box supporting assembly from the body frame in a plug-and-play manner. The support assemblies each include an active quick-release part and a driven quick-release part. The active quick-release part is connected to a motor output shaft assembly.

### CROSS-REFERENCE TO RELATED APPLICATIONS

This application is a continuation-in-part of International Patent Application No. PCT/CN2022/095988 with an international filing date of May 30, 2022, designating the United States, now pending, and further claims foreign priority benefits to Chinese Patent Application No. 202110868644.2 filed Jul. 30, 2021. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, MA 02142.

### BACKGROUND

The disclosure relates to the field of cooking machine, and more particularly to a feeding device for cooking machine.

Before cooking, one essential step is to put food material into a cooking machine using a feeding mechanism.

The connection of the feeding mechanism and the body frame of conventional cooking machine is complex, increasing the assembly difficulty and production costs.

The electromagnetic assembly is disposed in the feeding mechanism, and the feeding mechanism is electrically connected to other components outside the body frame, so that the feeding mechanism cannot be easily uninstalled for cleaning.

### SUMMARY

The disclosure provides a feeding device for cooking machine, comprising: a box supporting assembly, a food material box, a movable baffle, and support assemblies. The box supporting assembly comprises a base frame and a box frame; the box frame is disposed on one side of the base frame to support the food material box; the movable baffle is disposed on the base frame; the food material box comprises a discharging end attached to a lower surface of the movable baffle; the support assemblies are respectively disposed on two opposite sides of the base frame, and operate to hang the box supporting assembly modularly over a body frame of a cooking machine or detach the box supporting assembly from the body frame of the cooking machine in a plug-and-play manner; the support assemblies each comprise an active quick-release part and a driven quick-release part; the active quick-release part is connected to a motor output shaft assembly, and the driven quick-release part is connected to a connection base assembly fixedly disposed on the body frame; and with the rotation of the motor output shaft assembly, the box supporting assembly rotates to overturn the food material box by 180 degrees, and the discharging end of the food material box faces downward.

In a class of this embodiment, the active quick-release part comprises a primary sliding block and the driven quick-release part comprises a secondary sliding block; the primary sliding block and the secondary sliding block are fixedly disposed on two sides of the base frame, respectively; the motor output shaft assembly comprises an output shaft and a primary sliding chute; the primary sliding chute is disposed on the body frame and opposite to the primary sliding block; the primary sliding chute is fixedly connected to the output shaft; the connection base assembly comprises a driven shaft and a secondary sliding chute; the secondary sliding chute is disposed on the body frame through the driven shaft and opposite to the secondary sliding block; and the primary sliding block and the secondary sliding block cooperate to carry the box supporting assembly to move in the primary sliding chute and the secondary sliding chute.

In a class of this embodiment, the active quick-release part comprises a step shaft fixedly disposed on the base frame, and the driven quick-release part comprises a support shaft; the motor output shaft assembly comprises an output shaft and an axial clamping hole outside the output shaft; the step shaft is disposed in the axial clamping hole in a clamped and engaged state; the connection base assembly comprises a shaft seat disposed on the body frame, and one end of the support shaft is axially movable in the shaft seat.

In a class of this embodiment, the shaft seat comprises, from front to rear, a shaft sleeve, a limit sleeve, a spring cap, a spring, and a spring base; the body frame comprises a mounting hole; a rear end of the limit sleeve is inserted into the mounting hole and fixedly connected to the body frame; a front end face of the limit sleeve comprises an axial sleeve hole, and the shaft sleeve is embedded in the sleeve hole; the limit sleeve further comprises a cap channel that extends axially behind the sleeve hole; the spring cap is inserted into the cap channel from the back to the front; the spring base is fixedly connected to the body frame; an inner bottom surface of the spring base comprises an axial convex column; the spring is sleeved on the axial convex column and disposed inside the spring cap; the spring cap is movable back and forth in the cap channel; and one end of the support shaft is located in the shaft sleeve.

In a class of this embodiment, the shaft seat comprises a shaft sleeve, a spring, and a spring base in order from front to rear; the body frame comprises a mounting hole; the spring base is a coaxial double-cylinder structure with a front opening; an outer cylinder of the coaxial double-cylinder structure is fixedly connected to the body frame, and a spring plate is projected on an inner peripheral wall of an inner cylinder of the coaxial double-cylinder structure; a rear of the shaft sleeve comprises a sleeve structure with a rear opening; the sleeve is sleeved on an outer peripheral wall of the inner cylinder and is movable back and forth relative to each other; a limit structure is disposed on an outer wall of the sleeve to ensure that the sleeve is connected to the inner cylinder; the spring is disposed inside the inner cylinder and is disposed between a spring plate and an inner bottom surface of the sleeve; a front end of the shaft sleeve passes through the mounting hole, and comprises a shaft support hole; and one end of the support shaft is located in the shaft support hole; or, the shaft seat further comprises a rebounder behind the inner cylinder; a raised positioning post is disposed in the sleeve; a magnetic sheet is fixedly connected to the raised positioning post; the spring sleeves the raised positioning post and is disposed between a spring plate and an inner bottom surface of the sleeve; and the positioning post is disposed in the inner cylinder so that the magnetic sheet attracts the rebounder.

In a class of this embodiment, the shaft seat comprises a shaft sleeve sleeving one end of the support shaft and a limit plate; the body frame comprises a mounting hole; a rear end of the shaft sleeve is inserted into the mounting hole and fixedly connected to the body frame; the shaft sleeve comprises a through hole that runs through the shaft sleeve, and one end of the support shaft moves back and forth within the through hole; a front end of the shaft sleeve comprises a limit hole that runs radially through the shaft sleeve; the limit plate is inserted into the limit hole to limit the support shaft so that the step shaft and the output shaft are in an engagement state.

In a class of this embodiment, one side of the movable baffle is hinged above a cross beam inside the base frame, and the other side is a free side; an outer frame of the base frame comprises a pin hole disposed above the free side; a retractable pin is disposed in the pin hole for blocking the opening of the free side when the box supporting assembly is flipped 180 degrees; a front end of the pin is disposed on an inner side of the base frame, and a rear end is disposed on an outer side of the base frame and is connected to a permanent magnet; the pin is movable back and forth in the pin hole; the body frame comprises an electromagnetic assembly corresponding to the pin to attract and detach the pin from contact with the movable baffle.

In a class of this embodiment, the electromagnetic assembly comprises two coaxial and spaced coils and an iron core; a rear end of the iron core passes through one coil and is located inside another coil; a front end of the iron core extends forward, and a permanent magnetic block is disposed on a front-end face of the iron core; the iron core and the pin are disposed coaxially at intervals, and the two coils attract the iron core in opposite directions.

In a class of this embodiment, a funnel-shaped hopper is disposed on upper side of the base frame; an opening edge of a lower side of the hopper comprises an outer edge extending all around; and the outer edge is fixedly connected to the base frame through quick-release parts.

In a class of this embodiment, the box frame comprises two independent guide rails respectively disposed on two opposites side of a bottom of the base frame to support the food material box.

The following advantages are associated with the feeding device for cooking machine of the disclosure:

Compared with the related art, the feeding device of the disclosure features low production cost, easy assembly, and can achieve rapid installation and uninstallation with the body frame of a cooking machine. Each component can be dismounted and separated, thus facilitating the cleaning of the components, greatly improving the user experience.

### BRIEF DESCRIPTION OF THE DRAWINGS

FIG. 1 is a position relationship diagram of a body frame and a feeding device of a cooking machine according to one embodiment of the disclosure;

FIG. 2 is a schematic diagram of a feeding device in a feeding position according to one embodiment of the disclosure;

FIG. 3 is a schematic diagram of a body frame of a cooking machine according to one embodiment of the disclosure;

FIG. 4 is an exploded view of a feeding device according to one embodiment of the disclosure;

FIG. 5 is a bottom view of a hopper according to one embodiment of the disclosure;

FIG. 6 is a position relationship diagram of a base frame and electromagnetic assembles of a feeding device according to one embodiment of the disclosure;

FIG. 7 is a sectional view taken from line A-A in FIG. 6;

FIG. 8 is a schematic diagram of a front coil in a power-on state;

FIG. 9 is a schematic diagram of an iron core attracting a pin;

FIG. 10 is a schematic diagram of a rear coil in a power-on state;

FIG. 11 is a first exploded view of sliding blocks and sliding chutes according to one embodiment of the disclosure;

FIG. 12 is a second exploded view of sliding blocks and sliding chutes according to one embodiment of the disclosure;

FIG. 13 is a mounting diagram of a motor, a base frame, and a first automatic limiting shaft seat according to one embodiment of the disclosure;

FIG. 14 is an exploded view of a first automatic limiting shaft seat according to one embodiment of the disclosure;

FIG. 15 is a schematic diagram of a second automatic limiting shaft seat according to one embodiment of the disclosure;

FIG. 16 is an exploded view of a second automatic limiting shaft seat according to one embodiment of the disclosure;

FIG. 17 is a schematic diagram of a third automatic limiting shaft seat according to one embodiment of the disclosure;

FIG. 18 is an exploded view of a third automatic limiting shaft seat according to one embodiment of the disclosure;

FIG. 19 is a schematic diagram of a manual limiting shaft seat according to one embodiment of the disclosure; and

FIG. 20 is an exploded view of a manual limiting shaft seat according to one embodiment of the disclosure.

### DETAILED DESCRIPTION

To further illustrate the disclosure, embodiments detailing a feeding device for cooking machine are described below. It should be noted that the following embodiments are intended to describe and not to limit the disclosure.

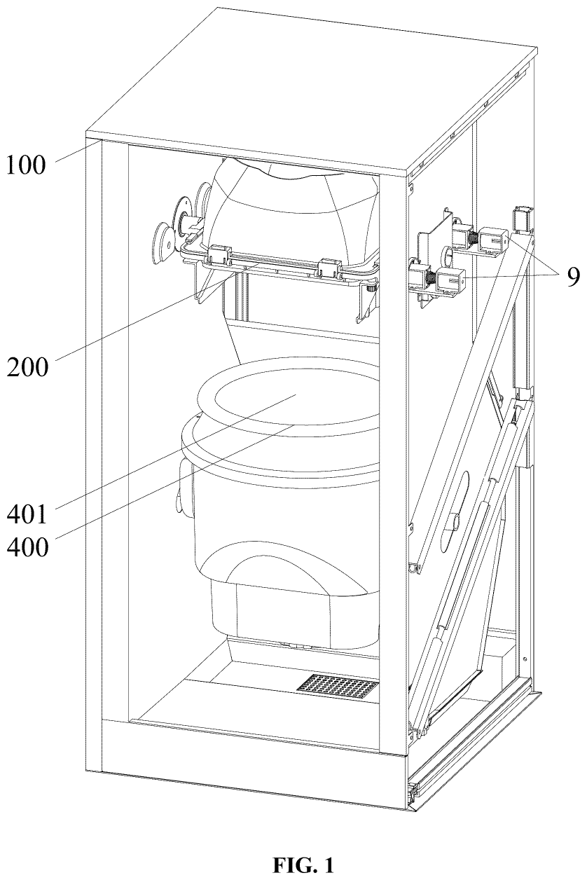

As shown in FIGS. 1-20, the disclosure provides a feeding device 200 for cooking machine. The feeding device 200 can be easily detached from or mounted on the body frame 100 of the cooking machine, which is convenient for users to clean and replace, effectively improving the user experience.

The feeding device 200 comprises a base frame 1, a movable baffle 2, a box frame, a hopper 5, a support assembly, and an electromagnetic assembly 9.

### 1. About the Base Frame 1 and the Movable Baffle 2 (the Directions of Up, Down, Left, Right, Front, and Back are Based on FIG. 1, the Same Below)

As shown in FIGS. 1-4, the base frame 1 is a load-bearing unit of the feeding device, and comprises an outer frame 11, a cross beam 12, and a longitudinal beam 13. In certain examples, the base frame 1 is opposite to the discharging end of the food material box 43. The outer frame, the cross beam, and the longitudinal beam form four feeding openings 14. The movable baffle 2 is correspondingly disposed above the four feeding openings 14 with equal area. A connection shaft 21 is disposed above the cross beam 12 for hinging the movable baffle 2; correspondingly, the outer frame 11 and the longitudinal beam 13 are provided with shaft holes 15. The connection shaft 21 passes through the hinged side 22 of the movable baffle 2 and the shaft holes 15 in the longitudinal beam 13, and two ends thereof are embedded into the shaft holes 15 of the outer frame 11. The movable side edges of the movable baffle 2 are attached to the narrow flaps 16 extending from the inside of the outer frame 11 to ensure that the movable baffle 2 always fit over the feeding openings 14.

Particularly, the movable baffle 2 is coated with a food grade anti stick coating, such as Teflon, to ensure that no food remains on the movable baffle 2 during the use of the fryer, and to facilitate automatic cleaning by the machine or manually.

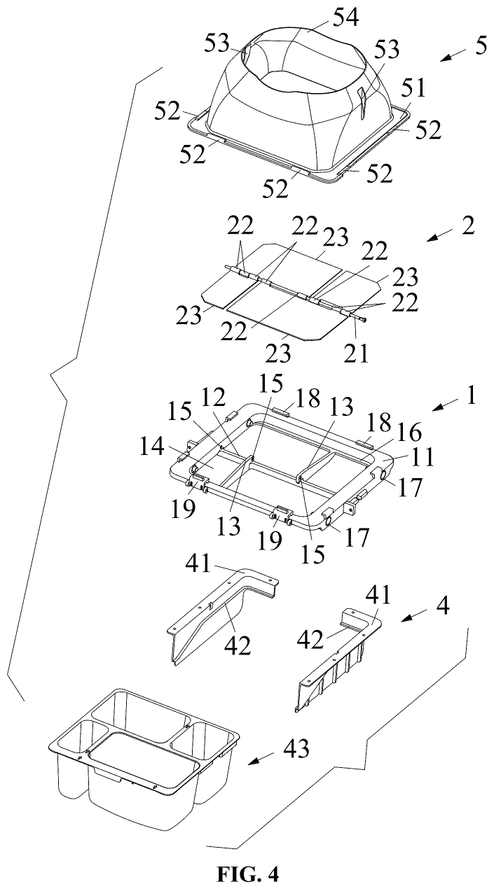

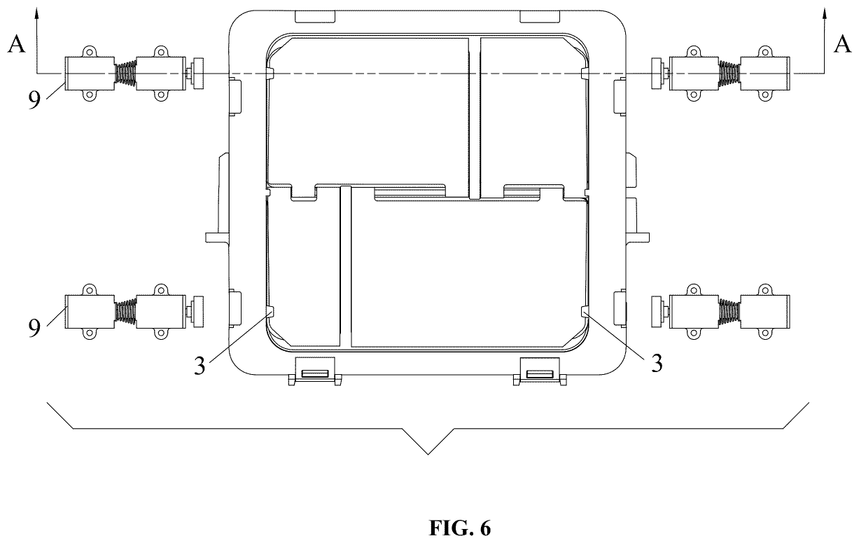

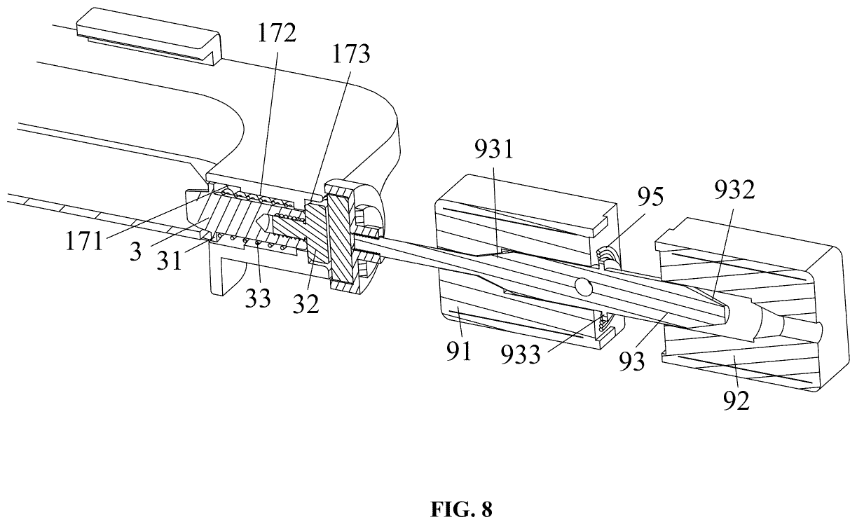

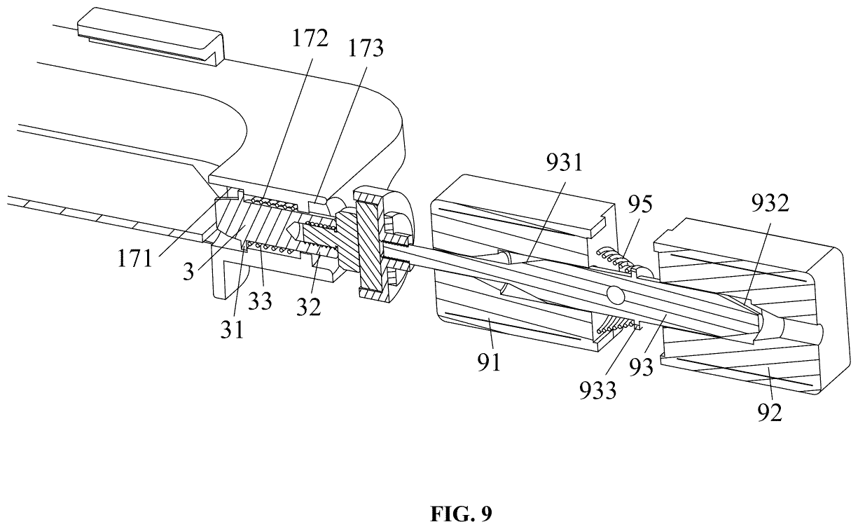

In reference to FIG. 4, FIG. 6 and FIG. 9, the left and right sides of the outer frame 11 are provided with pin holes 17. For the convenience of production, the pin holes 17 on the two sides are symmetrically disposed and the internal structures are also symmetrical. In each pin hole 17 disposed is a pin 3, and a reset spring 33 sleeves the pin 3. The front end of the pin 3 is located above the free side 23 of the movable baffle 2 and clamps the edge of the free side 23 between the pin and the narrow flaps 16. The front end of the pin 3 is located above the free side 23 of the movable baffle 2 and clamps the edge of the free side 23 between the pin and the narrow flaps 16. The pin hole 17 is a step hole, as shown in FIG. 8, from left to right, comprising a first step 171, a second step 172, and a third step 173. The inner diameter of the second step 172 is smaller than that of the first step 171 and the third step 173. The pin 3 is disposed in the first step 171 and the second step 172, and a limit ring 31 is sleeved on the front of the pin 3 and located in the first step 171. The outer diameter of the limit ring 31 is greater than the inner diameter of the second step 172. A permanent magnet 32 is fixedly connected to the rear end of the pin 3 and located in the third step 173. There are various fixing methods, such as clamping, pasting, and spinning. To make the structure simple and ensure firm installation, this example preferably uses the spinning method for fixing.

The pin 3 is movable back and forth in the step hole, with a moving distance between the limit ring 31 and the second step 172. When the pin 3 moves back, the front end of the pin 3 is located in the first step 171. At this time, the movable baffle 2 is not limited by the pin 3, and the free side 23 can rotate freely above the narrow flaps 16 along the connection shaft 21.

As shown in FIG. 4, the left, right, and rear surfaces of the outer frame 11 are provided with protrusions 18, and the front end face is equipped with clips 19. Both the protrusions 18 and clips 19 are used for quick connection and disconnection with the hopper 5, making it easy for production assembly and for users to maintain, clean, or replace the feeding device in the later stage.

### 2. About the Box Frame

As shown in FIGS. 1 and 4, the box frame is disposed below the base frame 1 to support the food material box 43. The box frame comprises two independent and opposite guide rails 4 located on the lower left and lower right sides of the base frame 1, and the internal structure of the two guide rails 4 is symmetrical on the left and right sides. The upper end of the guide rails 4 is provided with a connection edge 41 fitting with the lower surface of the outer frame 11. The connection edge 41 and the outer frame 11 are connected together by means of a nut and stud or connected by means of a snap joint (not shown) mounted on the lower side of the outer frame 11, which will not be discussed herein. As shown in FIG. 4, the center of the guide rails 4 is provided with a zigzag lug 42, so that the user can push the food material box 43 along the zigzag lugs 42 on the left and right sides into the box frame, and the zigzag lugs 42 can support the food material box 43 and hang the food material box 43 inside the stir-fry machine.

The bottom of the box frame is open, and during the automatic cleaning process of the cooking machine, the feeding device 200 is in the lower position, and the cleaning nozzle (not shown in the figure) on the top of the body frame 100 can directly spray towards the movable baffle 2 that has come into contact with the food materials. In the manual cleaning process, it is also convenient for users to directly clean the movable baffle 2 and the guide rails 4.

### 3. About the Hopper 5

As shown in FIGS. 1, 2 and 4, the hopper 5 is disposed above the base frame 1 to guide the food materials in the food material box 43 into a fry pan 400. Preferably, the hopper 5 in this example is a funnel-shaped structure with a guiding effect. The opening edge of the lower side of the hopper comprises an outer edge 51 extending all around. A plurality of convex blocks 52 protrude from the upper side of the outer edge 51. The convex blocks 52 of the outer edge 51 are inserted into the protrusions 18 on the outer frame 11, and the clips 19 are fastened to the convex blocks 52 on the front side of the outer edge 51. Thus, the hopper 5 can be quickly engaged with the outer frame 11, and the bottom surface of the hopper 5 is attached to the upper surface of the outer frame 11.

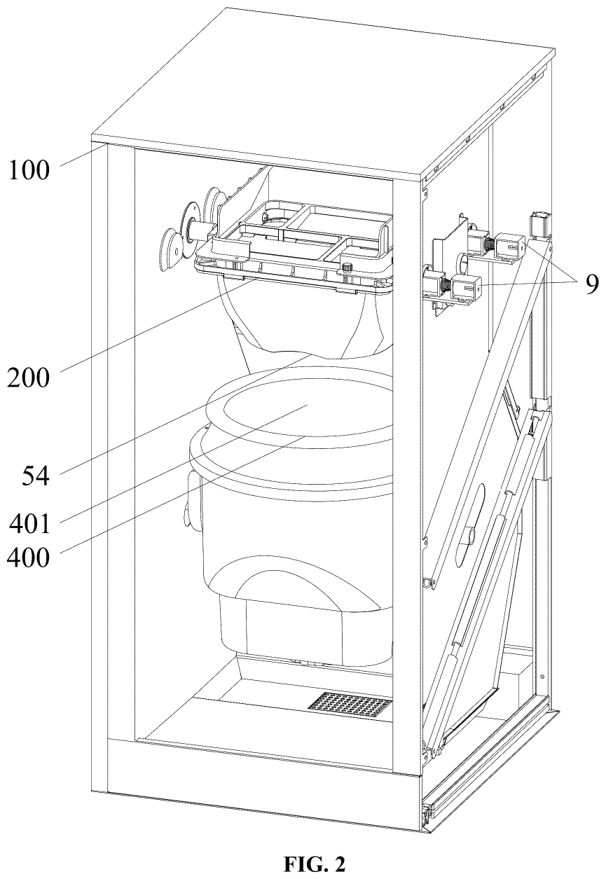

The lower opening of the hopper 5 is of the same shape and size as the inner ring of the outer frame 11, and the diameter of the upper opening 54 of the hopper 5 is smaller than or equal to the diameter of the pan opening 401, so as to ensure that when the feeding device 200 is rotated by 180 degrees and is in the feeding position (see FIG. 2), and the movable baffle 2 is opened, the food materials of each compartment of the food material box 43 will all fall into the pan along the hopper 5.

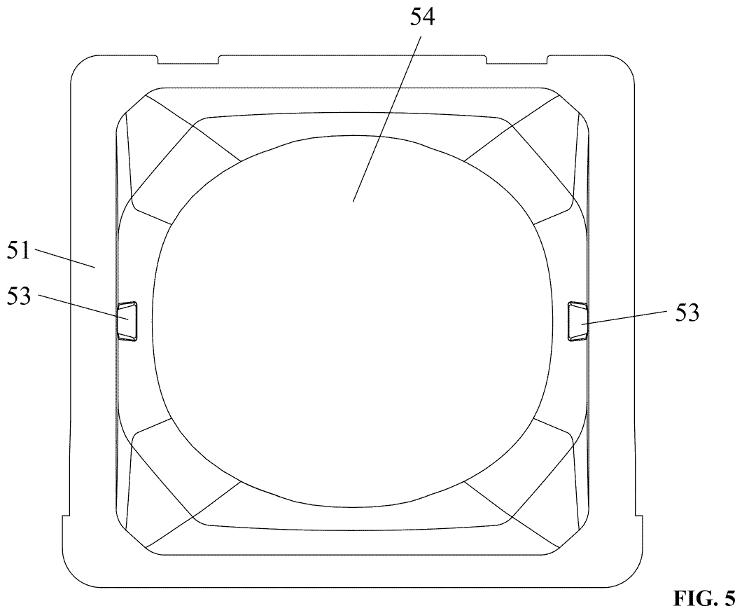

As shown in FIG. 5, two inwardly protruding limit blocks 53 are respectively disposed on the inner wall of the hopper 5 directly above the two ends of the connection shaft 21, thus preventing the movable baffle 2 from drooping (i.e., vertically facing downward) in the opening state when the feeding device 200 is in the feeding position, which not only prevents the free sides 23 of the two opposite movable baffles 2 from colliding with each other, but also ensures that the movable baffles 2 rotate to their respective original positions when the feeding device 200 is turned over, so that the movable baffles 2 are automatically reset to accurately cover the corresponding feeding openings 14.

### 4. About the Support Assembly

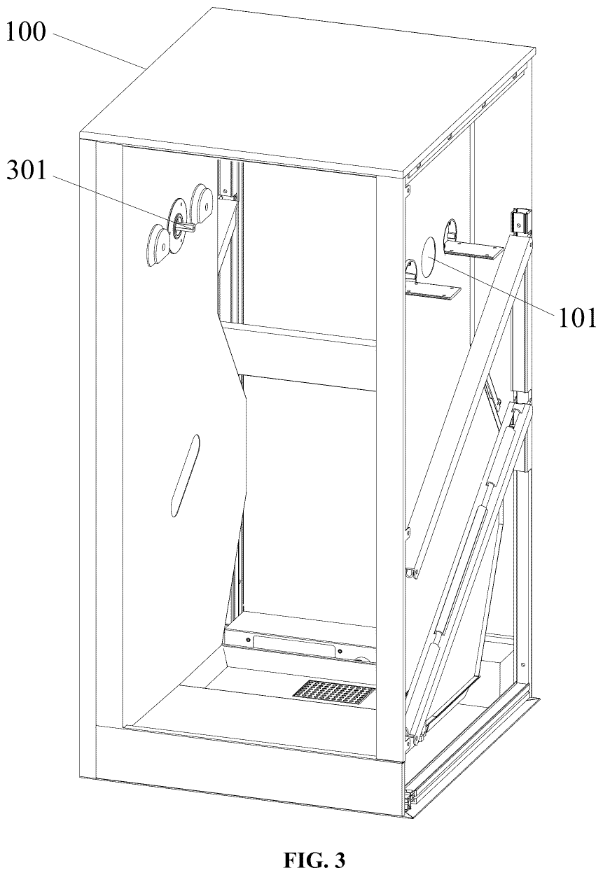

As shown in FIGS. 1 and 2, the support assembly is disposed on each side of the base frame 1 for hanging the feeding device 200 over the body frame 100 of the cooking machine, thus achieving the quick mounting and dismounting of the feeding device 200 with the body frame 100. The support assembly comprises an active quick-release part and a driven quick-release part. The active quick-release part is disposed on one side of the base frame and is connected to the motor output shaft 301, and the other side of the base frame is the driven quick-release part. As shown in FIG. 3, a motor 300 is disposed on the left side of the body frame 100, and a mounting hole 101 is disposed on the right side of the body frame 100, which is used for mounting the driven quick-release part.

Optionally, two support assemblies of the discourse are illustrated.

(1) Slider-Chute Structure (the Direction Facing the Base Frame 1 is Front, Vice Versa is Rear, the Same Below)

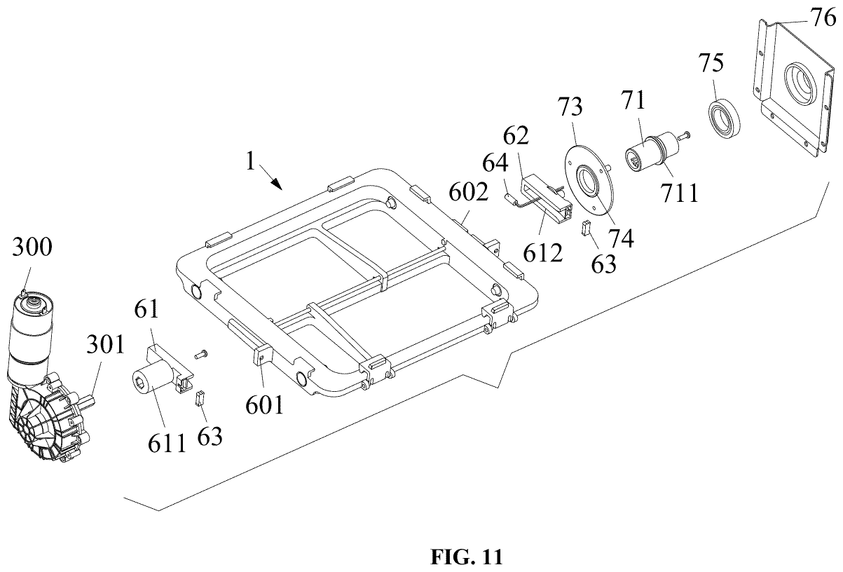

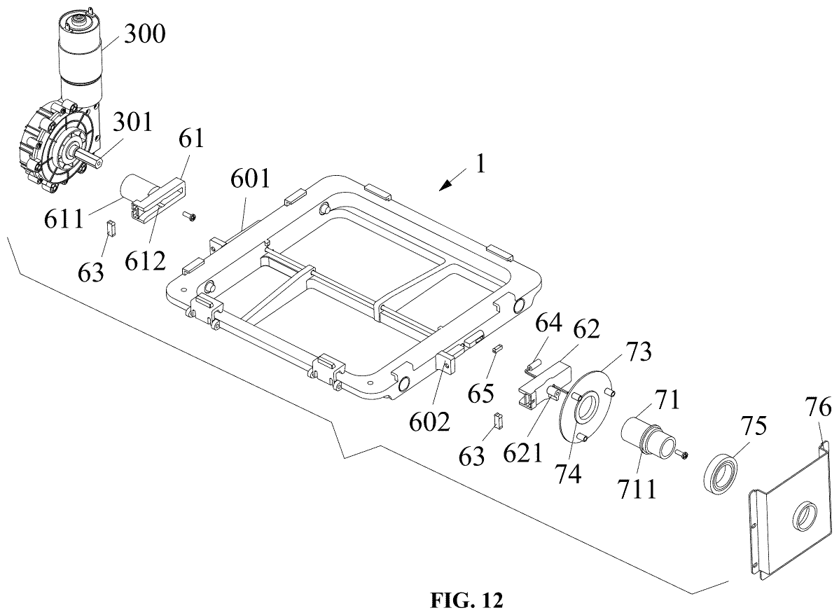

As shown in FIGS. 11 and 12, the left and right sides of the outer surface of the outer frame 11 are provided with sliding blocks, with the left side being a primary sliding block 601 and the right side being a secondary sliding block 602. Correspondingly, there are a primary sliding chute 61 and a secondary sliding chute 62 on both sides of the body frame 100, and the sliding blocks are inserted into the corresponding sliding chutes. The primary sliding chute 61 comprises a connecting part 611 and a first chute part 612; the connecting part 611 is fixedly connected to the motor output shaft 301, and the first chute part 612 is used to support the primary sliding chute 61. The secondary sliding chute 62 comprises a clamping part 621 and a second chute part 612; the clamping part 621 is fixedly connected to the front end of a driven shaft 71, and the second chute part 612 is used to support the secondary sliding block 602. The outer wall of the rear of the driven shaft 71 is convex with a clamping flange 711. The driven shaft 71 is installed on the body frame 100 through a fixing member. The fixing member comprises a waterproof board 73, an oil seal 74, a bearing 75, and a fixing piece 76. The waterproof board 73 and the oil seal 74 are disposed on the inner side of the mounting hole 101 of the body frame 100. The waterproof board 73 is fixedly connected to the mounting hole 101, and a central through-hole is provided on the waterproof board 73. The central through-hole is coaxially disposed with the mounting hole 101, and the oil seal is disposed in the central through-hole. The bearing 75 and the fixing piece 76 are disposed outside the mounting hole 101. The front end of the driven shaft 71 passes, from the outer side of the body frame 100, through the mounting hole 101 and the oil seal 74, and is fixed to the clamping part 621 of the secondary sliding chute 62. The front face of the clamping table 711 abuts against the oil seal 74, so that the water inside the body frame 100 cannot flow out of the body frame 100 through the oil seal 74, achieving the sealing effect. The fixing piece 76 comprises a central hole; the bearing 75 is embedded in the central hole, and its outer ring is tightly fitted with the fixing piece 76. The rear end of the driven shaft 71 passes through the inner ring of the bearing 75, the rear end of the clamping flange 711 abuts against the inner ring, and the fixing piece 76 is fixed on the body frame 100.

To ensure the stability of the connection between the sliding blocks and the sliding chutes, a strong magnet 63 is embedded on the front end faces connecting the sliding blocks and the sliding chutes. During the disassembly process of the feeding device 200, if the pulling force is greater than the attraction force of the strong magnet 63, it can be easily disassembled. To facilitate users to install the feeding device 200 into the cooking machine, a chamfer is also designed at the inlet end of the sliding chutes to facilitate the sliding blocks to be pushed into the sliding chutes. The cross-sectional shape of the sliding blocks is compatible with the cross-sectional shape of the sliding chutes, and can be in various shapes, such as rectangles, triangles, etc.

To ensure that the feeding device 200 of the cooking machine is installed in place before cooking, an induction switch is disposed between the sliding block and the sliding chute. The induction switch is a mechanical travel switch or a contactless induction switch. Due to the limited installation position and the need for good waterproof performance, it is preferred to use a magnetic spring switch between the primary sliding chute 61 and the primary sliding block 601. The reed switch 64 of the magnetic spring switch is fixedly connected to the secondary sliding chute 62. The reed switch 64 passes through the secondary sliding block 602 and the driven shaft 71, and is electrically connected to the main control circuit of the cooking machine. In contrast, the magnet 65 is embedded in the secondary sliding block 602.

As shown in FIG. 12, the primary sliding chute 61 is clamped to the motor output shaft 301 and fixedly connected through nuts and bolts. The secondary sliding chute 62 is fixedly connected to the driven shaft 71 and is mounted on the body frame 100 through the driven shaft 71. The motor output shaft 301 drives the primary sliding chute 61, which drives the primary sliding block 601 on the base frame 1 to rotate, causing the feeding device 200 to rotate in a vertical plane. The secondary sliding block 602, secondary sliding chute 62, and driven shaft 71 rotate with the rotation of the feeding device 200.

When installing the feeding device 200, align the sliding blocks with the sliding chutes on both sides and push them to the bottom, and the sliding block is engaged with the strong magnet 63 on the front end face of the sliding chute to complete the installation. When dismounting the feeding device 200, pull out the feeding device 200, the sliding block is disengaged with the strong magnet on the front end face of the sliding chute, and the sliding block is detached from the sliding chute to complete the disassembly.

The structure of the sliding blocks and the sliding chutes facilitates the mounting and dismounting of the feeding device 200, and users can operate with one hand, effectively improving the user experience of using the cooking machine.

### (2) Shaft and Shaft Sleeve Structure

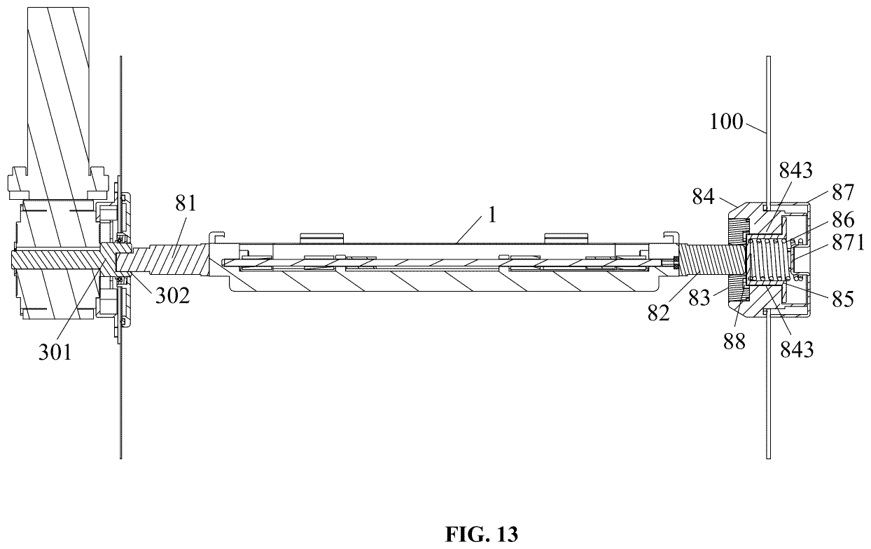

As shown in FIGS. 1 and 13, the left and right sides of the outer surface of the base frame 1 are equipped with shafts, with a step shaft 81 on the left and a support shaft 82 on the right. Correspondingly, the motor output shaft 301 is provided on the left side of the body frame 100 that is connected to the step shaft 81. The front end of the motor output shaft 301 comprises an axial clamping hole 302, and one end of the step shaft 81 is fixedly connected to the left side of the base frame 1, while the other end is a clamping block fitting with the axial clamping hole 302. The clamping block is clamped in the axial clamping hole 302. Various clamping methods can be used, such as D-shaped clamping, polygonal clamping, etc., which will not be elaborated here. The right side of the body frame 100 is provided with a shaft seat for supporting the end of the support shaft 82, which is installed on the mounting hole 101. To ensure the installation stability and convenience of the feeding device 200, the step shaft 81 is fixedly connected to the motor output shaft 301 through a clamping method. The support shaft 82 is movable axially within the shaft seat, and a limit structure is disposed inside the shaft seat. Users can first place the end of the support shaft 82 inside the shaft seat, move the feeding device 200 to the right, and then align the step shaft 81 with the motor output shaft 301 for clamping. The limit structure automatically limits or manually limits to ensure that the step shaft 81 and motor output shaft 301 always remain in a clamped and engaged state (as shown in FIG. 13).

### 1) Structure Option 1 of Automatic Limiting Shaft Seat

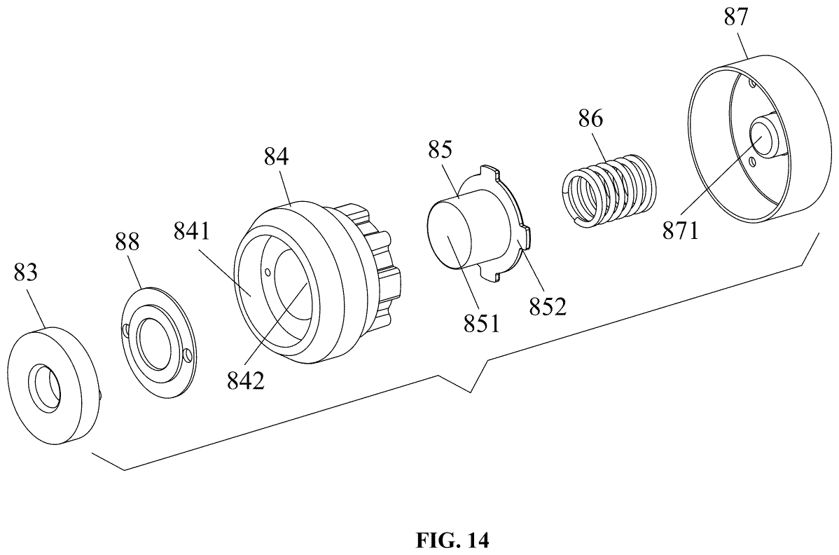

As shown in FIGS. 13 and 14, the shaft seat comprises, from front to rear, a shaft sleeve 83, a limit sleeve 84, a spring cap 85, a spring 86, and a spring base 87. The rear end of the limit sleeve 84 is inserted into the mounting hole 101 and fixedly connected to the body frame 100. The front end face of the limit sleeve 84 comprises an axial sleeve hole 841, and the shaft sleeve 83 is embedded in the sleeve hole 841. The shaft sleeve 83 is used to receive one end of the support shaft 82, which can rotate freely within the shaft sleeve 83. To reduce friction, a plastic shaft sleeve 83 with self-lubrication characteristics is adopted in the example. The limit sleeve 84 further comprises a cap channel 842 that extends axially behind the sleeve hole 841. The front of the cap channel 842 is convex with a clamping boss 843, and the spring cap 85 is inserted into the cap channel 842 from the back to the front. The brim part 852 of the spring cap abuts against the clamping boss 843. The spring base 87 is located at the rear end of the limit sleeve 84 and fixedly connected to the body frame 100. The inner bottom surface of the spring base 87 comprises an axial convex column 871 to prevent the spring 86 from deviating. The spring 86 is sleeved on the axial convex column 871 and disposed inside the spring cap 85.

One end of the support shaft 82 passes through the shaft sleeve 83 to compress the spring cap 85, and the spring cap 85 can move backwards until its brim part 852 is pressed against the spring base 87. When the spring cap 85 moves forward and resets due to the spring force, its brim part 852 is connected to the clamping boss 843, which can limit the spring cap 85 to continue moving forward. At this point, the top part 851 of the spring cap 85 abuts against the shaft sleeve 83.

To prevent water from flowing into the shaft sleeve 83 or out of the body frame 100 when the cooking machine automatically cleans the feeding device 200, a sealing ring 88 is disposed between the rear of the shaft sleeve 83 and the limit sleeve 84. The outer ring of the top part 851 of the spring cap 85 abuts against the sealing ring 88. There is also a sealing structure between the limit sleeve 84 and the mounting hole 101, as well as between the spring base 87 and the mounting hole 101 (not shown in the figures).

When installing the feeding device 200, the support shaft 82 is first placed in the shaft sleeve 83, and move the feeding device 200 to the right. At this point, the support shaft 82 compresses the spring cap 85, leaving the left side with a spare space for making the step shaft 81 and the motor output shaft 301 to be stuck. After the stuck connection is completed, the support shaft 82 is placed in the shaft sleeve 83, and the spring 86 will automatically reset the spring cap 85 to complete the installation; when uninstalling the feeding device 200, move the feeding device 200 to the right. At this point, the support shaft 82 compresses the spring cap 85, the step shaft 81 and the motor output shaft 301 are detached from the snap connection, and then the support shaft 82 is withdrawn from the shaft sleeve 83, and the spring cap 85 is automatically reset, completing the dismounting.

The automatic limiting shaft seat and the body frame 100 are firmly sealed, which makes the dismantling of the feeding device 200 convenient and no unnecessary manual operation steps, which can effectively improve the user experience of using the cooking machine.

### 2) Structure Option 2 of Automatic Limiting Shaft Seat

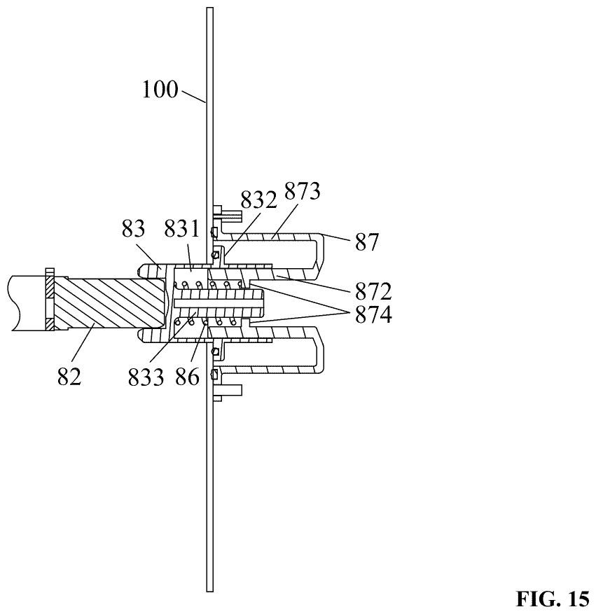

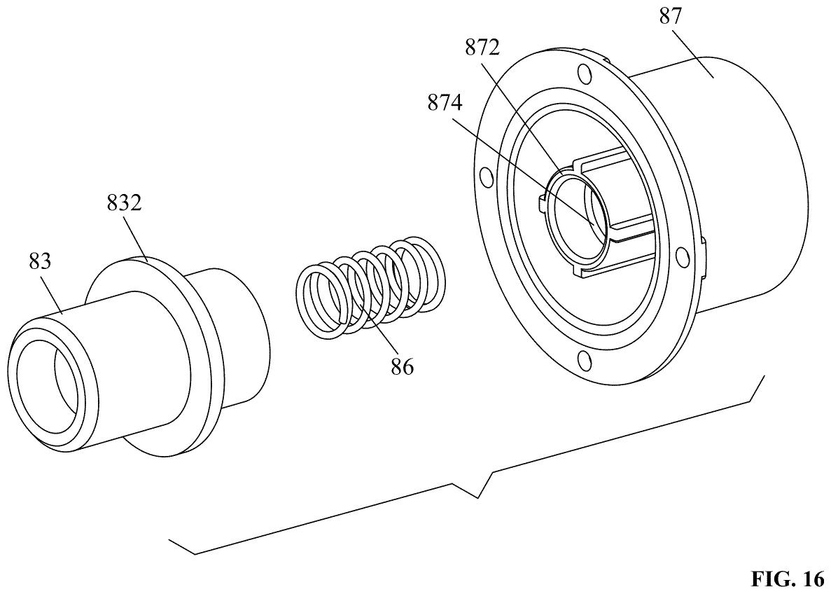

As shown in FIGS. 15 and 16, the shaft seat comprises a shaft sleeve 83, a spring 86, and a spring base 87 in order from front to rear. The spring base 87 is a coaxial double-cylinder structure with a front opening, the outer cylinder 873 of which is fixedly connected to the body frame 100, and a spring plate 874 is projected on the inner peripheral wall of the inner cylinder 872 of the coaxial double-cylinder structure. The shaft sleeve 83 comprises a shaft support hole on the front side, and the rear of the shaft sleeve 83 comprises a sleeve structure with a rear opening. A limiting tab 832 is disposed on the outer peripheral wall of the sleeve 831, and is located outside the body frame 100. Furthermore, a raised positioning post 833 is disposed on the inner bottom surface of the sleeve 831. The sleeve 831 is sleeved on the outer peripheral wall of the inner cylinder 872 and is movable back and forth relative to each other. The front end of the shaft sleeve 83 passes through the mounting hole 101 of the body frame 100, and one end of the support shaft 82 is located in the shaft support hole in the front face of the shaft sleeve 83 and is free to rotate. The spring is socketed to the raised positioning post 833 and disposed in the inner cylinder 872. The front end of the spring rests against the bottom surface of the sleeve 831, and the rear end thereof rests against the spring plate 874.

The end of the support shaft 82 compresses the shaft sleeve 83 backwards, and the shaft sleeve 83 can move backwards until the inner bottom surface of the sleeve 831 contacts the front end face of the inner cylinder 872. When the shaft sleeve 83 moves forward and resets due to the elastic force of the spring 86, the limiting tab 832 abuts against the body frame 100, and the limiting tab 832 limits the shaft sleeve 83 to continue moving forward.

To prevent water from flowing into the shaft sleeve 83 or out of the body frame 100 when the cooking machine automatically cleans the feeding device 200, a sealing ring (not shown in the figure) is disposed between the front end face of the limiting tab 832 and the mounting hole 101, and a sealing ring is also installed between the outer cylinder 873 and the body frame 100 (not shown in the figure).

When installing the feeding device 200, the user first places the support shaft 82 inside the shaft sleeve 83 and moves the feeding device 200 to the right. At this point, the support shaft 82 compresses the shaft sleeve 83 and moves it to the right, leaving ample space on the left side for the step shaft 81 to be clamped with the motor output shaft 301. After the clamping is completed, the spring 86 automatically resets the shaft sleeve 83 and completes the installation. When uninstalling the feeding device 200, move it to the right. At this point, the support shaft 82 compresses the shaft sleeve 83, and the step shaft 81 disengages from the motor shaft. Then, take out the support shaft 82 from the shaft sleeve 83, and the spring 86 automatically resets the shaft sleeve 83 to complete the uninstallation.

The automatic limiting shaft seat and the body frame 100 are firmly sealed, which makes the dismantling of the feeding device 200 convenient and no unnecessary manual operation steps. The structure is simple, effectively saving the internal space of the body frame 100, and can effectively enhance the user's experience of using the cooking machine.

### 3) Structure Option 3 of Automatic Limiting Shaft Seat

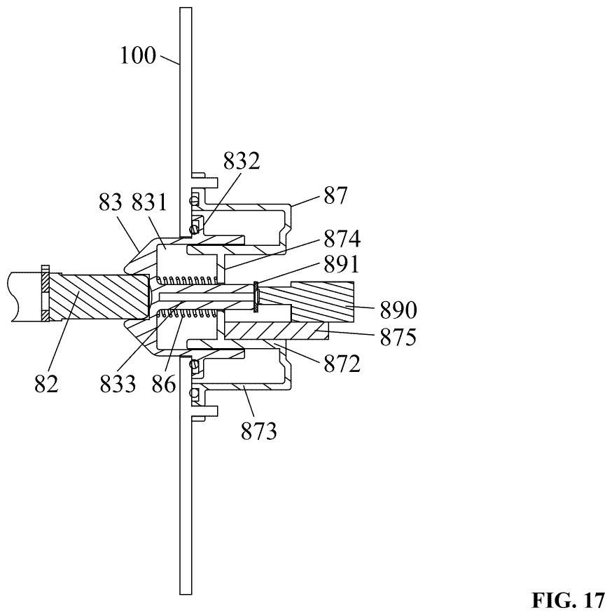

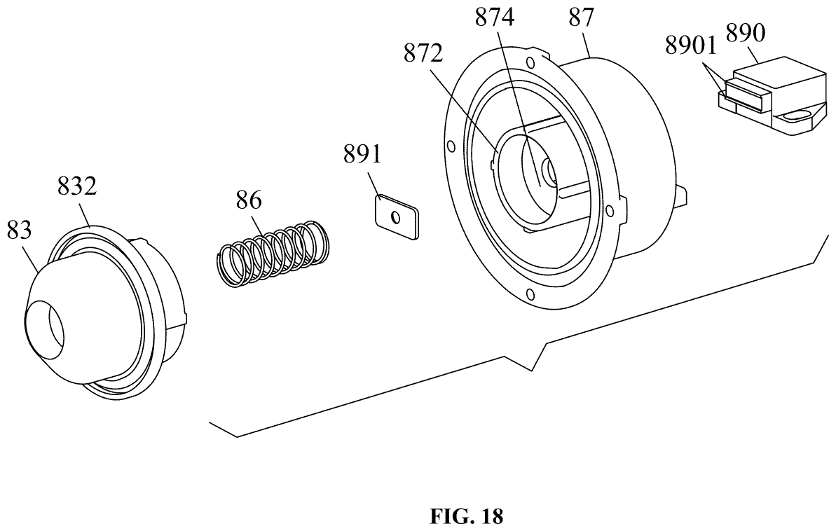

As shown in FIGS. 17 and 18, based on the structure option 2 of automatic limiting shaft seat, the structure option 3 of automatic limiting shaft seat further comprises a push-pull magnetic rebounder 890. The rebounder 890 is fixedly connected to a mounting seat 875 of the inner cylinder 872, and after the magnetic sheet 891 used in conjunction with the rebounder 890 is fixedly connected to the positioning post 833, the magnetic sheet 891 and the magnetic attraction portion 8901 of the rebounder 890 are always in an attraction state, and the attraction force therebetween is greater than the elastic force of the spring 86. The spring 86 in the structure option 3 of automatic limiting shaft seat is used to assist the rebounder 890 to send the shaft sleeve 83 out during the ejection process, to reduce the friction between the inner surface of the sleeve 831 and the outer surface of the inner cylinder 872 during the movement of the shaft sleeve 83, and to ensure the stability of the rebounder 890 to eject the shaft sleeve 83. If the spring force of the bouncer 890 is sufficient to eject out the shaft sleeve 83 smoothly, the spring 86 may not be provided.

The rebounder 890 is commercially available, such as the rebounder 890 of model ML-30SBR, and their functions and operating principles are not described herein.

Before installing the feeding device 200, the bouncer 890 is in the initial position (if it is in the ejector position, the bouncer 890 can be pressed into the initial position), the user will put the feeding device 200 into the body frame 100 in parallel and is located between the motor output shaft 301 and the shaft seat. The support shaft 82 is placed in the shaft sleeve 83 first, and then the feeding device 200 is moved to the right. At this point, the support shaft 82 compresses the shaft sleeve 83 to move to the right. The positioning post 833 presses the bouncer 890, making the bouncer 890 bounce. In the process of ejection of the bouncer 890, the user performs the snap joint of the step shaft 81 and the motor output shaft 301. After the snap joint is completed, the bouncer 890 is in the ejection position, thus completing the installation. To uninstall the feeding device 200, move the feeding device 200 to the right. At this point, the support shaft 82 compresses the shaft sleeve 83, and the positioning post 833 presses the rebounder 890, causing the rebounder 890 to return to the initial position. The step shaft 81 is disengaged from the motor output shaft 301, and then the support shaft 82 is removed from the shaft sleeve 83, completing the dismantling.

### 4) Manual Limiting Shaft Seat

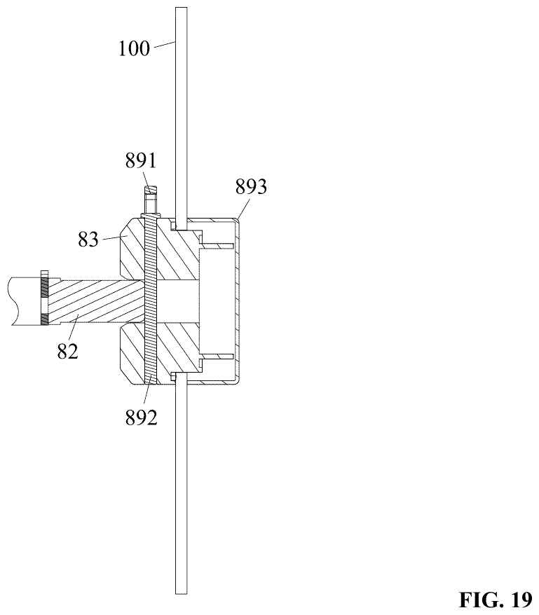

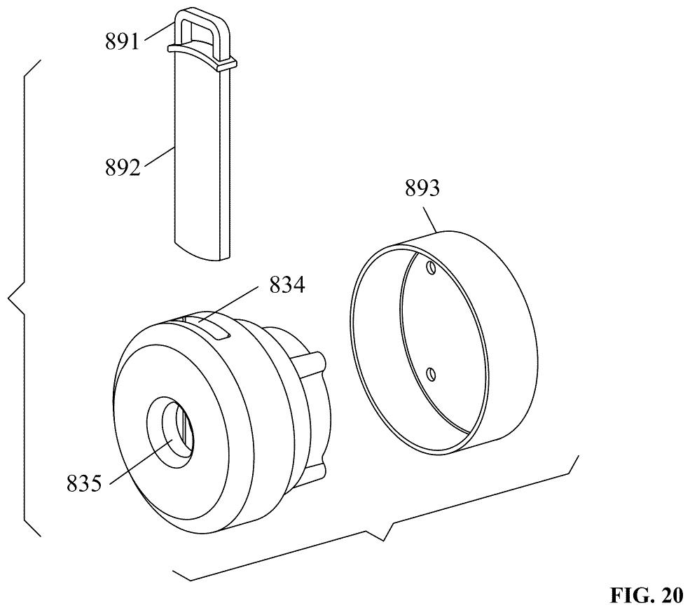

As shown in FIGS. 19 and 20, the shaft seat comprises a shaft sleeve 83 and a limit plate 892 from front to rear. The rear end of the shaft sleeve 83 is inserted into the mounting hole 101 and fixedly connected to the body frame 100. The shaft sleeve 83 comprises a through hole 835 that runs through the shaft sleeve 83, and the end of the support shaft 82 moves back and forth within the through hole. The front end of the shaft sleeve 83 comprises a limit hole 834 that runs radially through the shaft sleeve 83. The limit plate 892 is inserted into the limit hole 834 to limit the support shaft 82 so that the step shaft 81 and the output shaft 301 are in an engagement state. To effectively prevent dust outside the body frame 100 from entering the shaft sleeve 83, a protective cover 893 is disposed on the rear end of the shaft sleeve 83, and is fixedly connected to the body frame 100. To facilitate users to remove the limit plate 892 from the limit hole 834 or insert the limit plate 892 into the limit hole 834, a handle 891 is disposed on the top of the limit plate 892, which is always located outside the shaft sleeve 83. To prevent water from flowing into the shaft sleeve 83 or out of the body frame 100 when the cooking machine automatically cleans the feeding device 200, a sealing structure is also disposed between the shaft sleeve 83 and the mounting hole 101, as well as between the protective cover 893 and the mounting hole 101 (not shown in the figure).

When installing the feeding device 200, first take out the limit plate 892 from the limit hole 834, and then place the support shaft 82 in the shaft sleeve 83. Move the feeding device 200 to the right, leaving ample space on the left for the step shaft 81 to engage with the motor output shaft 301. After the engagement is completed, manually insert the limit plate 892 into the limit hole 834. After the installation is completed, the step shaft 81 and the motor output shaft 301 remain engaged and connected. When uninstalling the feeding device 200, manually withdraw the limit plate 892 from the limit hole 834, move the feeding device 200 to the right, detach the step shaft 81 from the output shaft 301, and then remove the support shaft 82 from the shaft sleeve 83 to complete the disassembly.

The manual limiting shaft seat and the body frame 100 are firmly sealed, and its installation structure is simple, effectively reducing the production costs.

### 5. About the Electromagnetic Assembly 9

As shown in FIGS. 1, 2 and 6, the electromagnetic assembles 9 are disposed oppositely to the pin 3. The electromagnetic assembles 9 are installed outside the body frame 100, and the front end of the iron core of the electromagnetic assembles 9 comprises a permanent magnetic block 94 disposed inside the body frame 100. When the feeding device 200 is turned 180 degrees and in the feeding position, the electromagnetic assembles 9 attract the pin 3 to open the movable baffle 2, and the food materials in the compartment fall into the fry pan 400 to complete the feeding process.

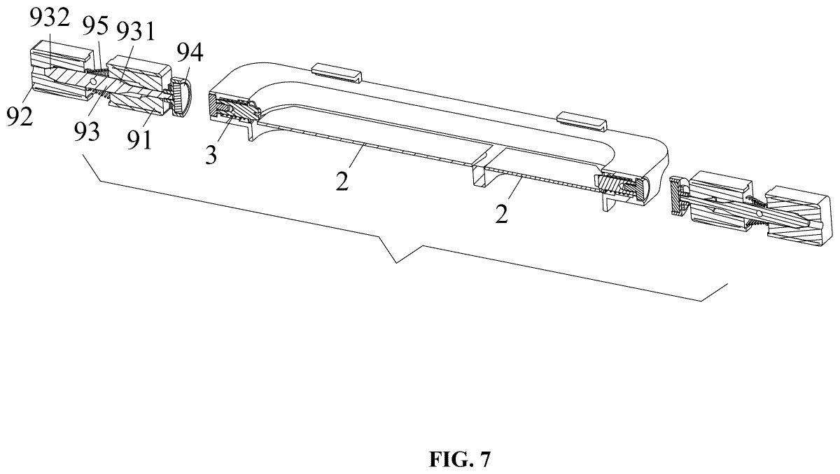

As shown in FIGS. 7-10, each of the electromagnetic assembles 9 comprises two coaxial and spaced coils and an iron core. The front end of the iron core extends forward through the coils into the body frame 100 and faces the pin 3, and the front end is in threaded connection to the permanent magnetic block 94. The front end is movable forward and backward within the two coils. The coil for moving the iron core forward is a front coil 91 and the coil for moving the iron core backward is a rear coil 92. Correspondingly, the iron core 93 in the front coil 91 comprises a front attraction portion 931 and the iron core 93 in the rear coil 92 comprises a rear attraction portion 932. A contact ring 933 is provided on the iron core 93 at the interval between the two coils and the iron core 93 is sheathed with a spring. The spring can reset the iron core 93 when both coils are powered off. To reduce the axial space occupied by spring compression, a tower spring 95 is preferred. The bottom of the tower spring 95 abuts against the rear end face of the outer shell of the front coil 91, and the top abuts against the contact ring 933 of the iron core 93. The spring force of the tower spring 95 is greater than the spring force of the reset spring 33 on the pin 3. When all the coils are not energized, the permanent magnetic block 94 on the iron core 93 is attracted to the permanent magnet 32 on the pin 3. The tower spring 95 drives the pin 3 to move backwards, causing the front end of the pin 3 to be accommodated in the first step 171, and the limit ring 31 abuts against the second step 172.

As shown in FIGS. 2 and 8, when the feeding device 200 is in a feeding position and the front coil 91 is powered on, the front coil 91 attracts the front attraction portion 931 of the iron core 93, and the iron core 93 moves forward. The tower spring 95 is compressed by the contact ring 933, and the permanent magnet block 94 attracts the permanent magnet 32 on the pin 3.

As shown in FIG. 9, after the front coil 91 is powered off, the tower spring 95 resets the iron core 93 and moves it backwards. The pin 3 follows the iron core 93 and moves backwards. The front end face of the pin 3 is located in the first step 171, and the limit ring 31 abuts against the second step 172. The pin 3 detaches from the movable baffle 2, and the movable baffle 2 opens due to its own gravity, completing the feeding of food materials in the food materials bin.

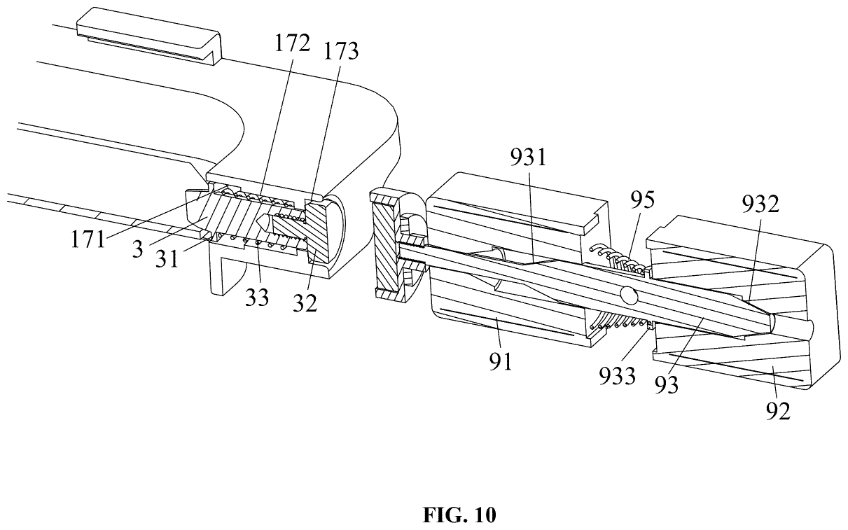

As shown in FIGS. 1 and 10, when the feeding is finished and the feeding device 200 has returned to its original position, the movable baffle 2 covers the feeding openings 14 due to gravity. The rear coil 92 is powered on, and attracts the rear attraction portion 932 of the iron core 93. The iron core 93 moves backwards. Before abutting against the second step 172, the limit ring 31 on the pin cannot move backwards with the iron core 93. The permanent magnet 32 is detached from the permanent magnet block 94, and the reset spring 33 on the pin 3 resets the pin 3, the rear coil 92 is powered off, completing the reset.

### 6. Working Process of the Feeding Device 200 for Use in a Cooking Machine

The motor 300 is preferably a stepper motor, with the starting position of the motor 300 being the original position of the feeding device 200. After turning of 180 degrees clockwise, the feeding device 200 changes to a feeding position.

The food material box 43 containing food materials is placed in advance in the box frame. During a frying process, when the main control center of the cooking machine issues a feeding command, the feeding device 200 will axially rotate 180 degrees backward. The movable baffle 2 will overlap on the pin 3 due to gravity, and the feeding openings of the food material box 43 face directly the movable baffle 2. Each electromagnetic assembly 9 will start according to the feeding command requirements, and the front coil 91 is powered on. The permanent magnet 32 on the front end of the iron core 93 is attracted to the permanent magnet 32 on the rear end of the pin 3. The front coil 91 is powered off, and the pin 3 moves backwards. The front face of the pin enters the first step 171, and is detached from the movable baffle 2. The movable side of the movable baffle 2 rotates downwards due to gravity and overlaps with the limit blocks 53 of the hopper 5. At this point, the food materials slide into the frying pan 400 after passing through the movable baffle 2 and the hopper 5 due to gravity, completing the feeding of the food materials. Different electromagnetic assembles 9 will control different food material bins to complete the feeding in an orderly manner according to the instructions from the main control center.

After the frying is completed, the main control center of the cooking machine sends a reset command, and the feeding device 200 rotates 180 degrees forward to return to its original position. The movable baffle 2 is closed on the feeding openings 14 due to gravity. The rear coil 92 in all electromagnetic assembles 9 is energized, and the permanent magnet 32 on the pin 3 is detached from the permanent magnet block 94 on the iron core 93. The reset spring 33 causes the pin 3 to reset, and the rear coil 92 is powered off. The tower spring 95 causes the iron core 93 to reset, thus completing the reset operation.

Understandably, the feeding device 200 in this embodiment is only applicable to the food material box 43 with the same feeding openings 14 as that of the base frame 1. If the feeding openings of the food material box 43 is different from that in the embodiment, the shape, height, and size of the base frame 1, the box frame, the hopper 5, and the movable baffle 2 can be adjusted according to the shape of the feeding openings and box body.

It will be obvious to those skilled in the art that changes and modifications may be made, and therefore, the aim in the appended claims is to cover all such changes and modifications.

What is claimed is:

1. A feeding device for cooking machine, the device comprising:
a box supporting assembly;
a food material box;
a movable baffle; and
support assemblies;
wherein:
the box supporting assembly comprises a base frame and a box frame; the box frame is disposed on one side of the base frame to support the food material box;
the movable baffle is disposed on the base frame;
the food material box comprises a discharging end attached to a lower surface of the movable baffle;
the support assemblies are respectively disposed on two opposite sides of the base frame, and operate to hang the box supporting assembly modularly over a body frame of a cooking machine or detach the box supporting assembly from the body frame of the cooking machine in a plug-and-play manner;
the support assemblies each comprise an active quick-release part and a driven quick-release part;
the active quick-release part is connected to a motor output shaft assembly, and the driven quick-release part is connected to a connection base assembly fixedly disposed on the body frame; and
with the rotation of the motor output shaft assembly, the box supporting assembly rotates to overturn the food material box by 180 degrees, and the discharging end of the food material box faces downward.

2. The feeding device for cooking machine of claim 1, wherein the active quick-release part comprises a primary sliding block and the driven quick-release part comprises a secondary sliding block; the primary sliding block and the secondary sliding block are fixedly disposed on two sides of the base frame, respectively; the motor output shaft assembly comprises an output shaft and a primary sliding chute; the primary sliding chute is disposed on the body frame and opposite to the primary sliding block; the primary sliding chute is fixedly connected to the output shaft; the connection base assembly comprises a driven shaft and a secondary sliding chute; the secondary sliding chute is disposed on the body frame through the driven shaft and opposite to the secondary sliding block; and the primary sliding block and the secondary sliding block cooperate to carry the box supporting assembly to move in the primary sliding chute and the secondary sliding chute.

3. The feeding device for cooking machine of claim 1, wherein the active quick-release part comprises a step shaft fixedly disposed on the base frame, and the driven quick-release part comprises a support shaft; the motor output shaft assembly comprises an output shaft and an axial clamping hole outside the output shaft; the step shaft is disposed in the axial clamping hole in a clamped and engaged state; the connection base assembly comprises a shaft seat disposed on the body frame, and one end of the support shaft is axially movable in the shaft seat.

4. The feeding device for cooking machine of claim 3, wherein the shaft seat comprises, from front to rear, a shaft sleeve, a limit sleeve, a spring cap, a spring, and a spring base; the body frame comprises a mounting hole; a rear end of the limit sleeve is inserted into the mounting hole and fixedly connected to the body frame; a front end face of the limit sleeve comprises an axial sleeve hole, and the shaft sleeve is embedded in the sleeve hole; the limit sleeve further comprises a cap channel that extends axially behind the sleeve hole; the spring cap is inserted into the cap channel from the back to the front;
the spring base is fixedly connected to the body frame; an inner bottom surface of the spring base comprises an axial convex column; the spring is sleeved on the axial convex column and disposed inside the spring cap; the spring cap is movable back and forth in the cap channel; and one end of the support shaft is located in the shaft sleeve.

5. The feeding device for cooking machine of claim 3, wherein the shaft seat comprises a shaft sleeve, a spring, and a spring base in order from front to rear; the body frame comprises a mounting hole; the spring base is a coaxial double-cylinder structure with a front opening; an outer cylinder of the coaxial double-cylinder structure is fixedly connected to the body frame, and a spring plate is projected on an inner peripheral wall of an inner cylinder of the coaxial double-cylinder structure; a rear of the shaft sleeve comprises a sleeve structure with a rear opening; the sleeve is sleeved on an outer peripheral wall of the inner cylinder and is movable back and forth relative to each other; a limit structure is disposed on an outer wall of the sleeve to ensure that the sleeve is connected to the inner cylinder; the spring is disposed inside the inner cylinder and is disposed between a spring plate and an inner bottom surface of the sleeve; a front end of the shaft sleeve passes through the mounting hole, and comprises a shaft support hole; and one end of the support shaft is located in the shaft support hole;
or, the shaft seat further comprises a rebounder behind the inner cylinder; a raised positioning post is disposed in the sleeve; a magnetic sheet is fixedly connected to the raised positioning post; the spring sleeves the raised positioning post and is disposed between a spring plate and an inner bottom surface of the sleeve; and the positioning post is disposed in the inner cylinder so that the magnetic sheet attracts the rebounder.

6. The feeding device for cooking machine of claim 3, wherein the shaft seat comprises a shaft sleeve sleeving one end of the support shaft and a limit plate; the body frame comprises a mounting hole; a rear end of the shaft sleeve is inserted into the mounting hole and fixedly connected to the body frame; the shaft sleeve comprises a through hole that runs through the shaft sleeve, and one end of the support shaft moves back and forth within the through hole; a front end of the shaft sleeve comprises a limit hole that runs radially through the shaft sleeve; the limit plate is inserted into the limit hole to limit the support shaft so that the step shaft and the output shaft are in an engagement state.

7. The feeding device for cooking machine of claim 1, wherein one side of the movable baffle is hinged above a cross beam inside the base frame, and the other side is a free side; an outer frame of the base frame comprises a pin hole disposed above the free side; a retractable pin is disposed in the pin hole for blocking the opening of the free side when the box supporting assembly is flipped 180 degrees; a front end of the pin is disposed on an inner side of the base frame, and a rear end is disposed on an outer side of the base frame and is connected to a permanent magnet; the pin is movable back and forth in the pin hole; the body frame comprises an electromagnetic assembly corresponding to the pin to attract and detach the pin from contact with the movable baffle.

8. The feeding device for cooking machine of claim 7, wherein the electromagnetic assembly comprises two coaxial and spaced coils and an iron core; a rear end of the iron core passes through one coil and is located inside another coil; a front end of the iron core extends forward, and a permanent magnetic block is disposed on a front-end face of the iron core; the iron core and the pin are disposed coaxially at intervals, and the two coils attract the iron core in opposite directions.

9. The feeding device for cooking machine of claim 7, wherein a funnel-shaped hopper is disposed on upper side of the base frame; an opening edge of a lower side of the hopper comprises an outer edge extending all around; and the outer edge is fixedly connected to the base frame through quick-release parts.

10. The feeding device for cooking machine of claim 1, wherein the box frame comprises two independent guide rails respectively disposed on two opposites side of a bottom of the base frame to support the food material box.

11. The feeding device for cooking machine of claim 9, wherein the box frame comprises two independent guide rails respectively disposed on two opposites side of a bottom of the base frame to support the food material box.
